(19) United States
(12) Patent Application Publication
(10) Pub. No.: US 2005/0196539 A1
(43) Pub. Date: Sep. 8, 2005

(54) Method of impregnation with agent

(75) Inventors: Kaoru Masuda, Kobe-shi (JP); Katsuyuki Iijima, Kobe-shi (JP)

Correspondence Address: REED SMITH LLP;SUITE 1400, 3110 FAIRVIEW PARK DR., FALLS CHURCH, VA, 22032, US

(73) Assignee: Kabushiki Kaisha Kobe Seiko Sho

(21) Appl. No.: 11/062,474

(22) Filed: Feb. 22, 2005

(30) Foreign Application Priority Data
Mar. 5, 2004 (JP) 2004-062926

(51) Int. Cl. B05D 7/00

(52) U.S. Cl. 427/377

(57) ABSTRACT

A method impregnates a material with an agent, by forming an agent-containing phase having a low density and containing an agent and carbon dioxide in a supercritical or subcritical state, and increasing the density of the agent-containing phase. This method can effectively impregnate a material having fine voids or pores with an agent in a short time by using supercritical or subcritical carbon dioxide.

### BACKGROUND OF THE INVENTION

1. Field of the Invention

The present invention relates to a useful method for efficiently impregnating a variety of porous materials having fine and complicated voids or pores with an agent, such as impregnation of wood with an antiseptic agent, addition of an active agent to a catalyst or activated carbon, impregnation of a porous ceramic with an agent, and impregnation of a polymeric material with an agent.

2. Description of the Related Art

A material is conventionally impregnated with an agent, for example, by immersing the target material in a liquid agent as intact or in a solution of the agent in water or an organic solvent. In this procedure, the impregnation may be accelerated by pressurizing the liquid agent or the solution. Alternatively, a material is impregnated with an agent by using a fluid in a supercritical state instead of the aqueous solution or the solution in the organic solvent, since such a fluid in a supercritical state may have a higher diffusibility and/or a lower viscosity than a liquid.

When a porous material such as wood is immersed in a solution of an agent, the agent must diffuse into the porous material to impregnate the porous material with the agent. If about 1 mm deep from the surface of the material should be impregnated with the agent, it takes about 1000 seconds for the porous material to be impregnated with the agent to a depth of about 1 mm from the surface, since the average diffusion length corresponds to the equation: 10⁻³=(Dt)^{0.5}, assuming that the diffusion coefficient D of the agent solution stands at 10⁻⁹ m²/s, equivalent to that of free water. To impregnate the material with the agent to a depth of 10 mm from the surface, however, it takes 10⁵ seconds (27 hours) according to the above equation.

As possible solutions to this problem, a method of forcedly injecting a liquid under pressure into pores (hereinafter briefly referred to as “liquid pressurizing method”, such as Japanese Industrial Standard (JIS) A9002), and a method of using a supercritical fluid having a high diffusion coefficient (hereinafter referred to as “simple supercritical fluid method”, for the sake of distinguishing from the present invention) have been attempted. These methods, however, have the following problems.

In the liquid pressurizing method, the atmosphere (air) generally remains in voids and pores in a porous material to which a liquid is injected, and, upon injection of the liquid, the air encapsulated in the porous material cannot escape to yield a differential pressure which collapses the porous material itself. Accordingly, the air must be removed by evacuation using, for example, a vacuum pump before impregnation of the agent. Even according to the liquid pressurizing method, however, such a liquid having a viscosity of about 1 cP cannot penetrate fine and narrow voids and pores.

As the simple supercritical fluid method, Japanese Unexamined Patent Application Publication No. 59-101311, U.S. Pat. No. 6,517,907 and U.S. Pat. No. 6,623,660 each propose a method for injecting an antiseptic agent into wood by using carbon dioxide (hereinafter referred to as “CO₂”) in a supercritical state. These documents mention that this technique is superior to conventional equivalents, since such a supercritical fluid easily penetrates the wood. However, it often takes a long time for an agent to penetrate wood by diffusion, because the diffusion coefficient of the agent in CO₂ is not so much larger on the order of several digits than that in water. In addition, the agent cannot be dissolved in CO₂ unless CO₂ has a somewhat high density, such as liquid CO₂ or gaseous CO₂ under very high pressure. Under these conditions, however, CO₂ shows a decreased diffusion coefficient. Gaseous CO₂ or CO₂ under low pressure each exhibiting a high diffusion coefficient does not sufficiently dissolve such an agent therein.

### SUMMARY OF THE INVENTION

Accordingly, an object of the present invention is to solve the problems in conventional technologies and to provide a method for effectively impregnating a material having fine voids or pores with an agent in a short time by using supercritical or subcritical CO₂.

Under intensive investigations, the present invention has been accomplished to achieve the above object.

In a 1st aspect, specifically, the present invention provides a method for impregnating a material with an agent, comprising the steps of forming an agent-containing phase having a low density and comprising an agent and CO₂ in a supercritical or subcritical state; and increasing the density of the agent-containing phase to thereby impregnate the material with the agent.

In a 2nd aspect, the material can be wood or lumber.

In a 3rd aspect, the method may further include the step of increasing the pressure on the agent-containing phase to thereby increase the density of the agent-containing phase.

In a 4th aspect, the method may include the steps of mixing the agent with CO₂ to form an agent-containing phase; bringing wood into contact with the agent-containing phase at a pressure of 5 to 20 MPa; and increasing the pressure to 10 to 40 MPa to thereby impregnate the wood with the agent.

In a 5th aspect, the method may include the steps of bringing wood into contact with CO₂ at a pressure of 10 to 40 MPa; adding the agent to the CO₂ being in contact with the wood; reducing the pressure to 5 to 20 MPa; and increasing the pressure to 10 to 40 MPa to thereby impregnate the wood with the agent.

In a 6th aspect, in the method, the ratio of the increased density of the agent-containing phase to that before increasing may be 1.2 or more.

According to the present invention, a variety of materials such as wood can be effectively impregnated with an agent in a short time, by utilizing a change in density of an agent-containing phase comprising the agent and supercritical or subcritical CO₂. In addition, the agent can reliably penetrate deep into the material by using a relatively simple technique such as pressure control. Thus, the present invention is also advantageous in practical use.

Further objects, features and advantages of the present invention will become apparent from the following description of the preferred embodiments with reference to the attached drawings.

### BRIEF DESCRIPTION OF THE DRAWINGS

FIG. 1 is a graph showing the relationship among the density, temperature and pressure of CO₂;

FIGS. 2 to 6 are schematic diagrams sequentially showing an impregnation mechanism according to the present invention;

FIG. 7 is a graph showing the relationship among the density ratio and the pressures before and after increasing the density, when the density is changed by pressure control according to the present invention; and

FIG. 8 is a flowchart of an apparatus used in the examples according to the present invention.

### DESCRIPTION OF THE PREFERRED EMBODIMENTS

After intensive investigations to achieve the object, the present inventors have found that a material can be very effectively impregnated with an agent by changing the density of an agent-containing CO₂ phase (hereinafter briefly referred to as “agent-containing phase”) comprising supercritical or subcritical CO₂ and the agent once to a low density and then changing to a high density.

Initially, the principle and operation of the present invention will be described in detail below.

CO₂ has a critical point at relatively low temperature and pressure (31° C., 7.4 MPa). Substances generally show large changes in their physical properties in the vicinity of their critical points. CO₂ also exhibits a large change in density at temperatures and pressures in the vicinity of its critical point, 31° C. and 7.4 MPa.

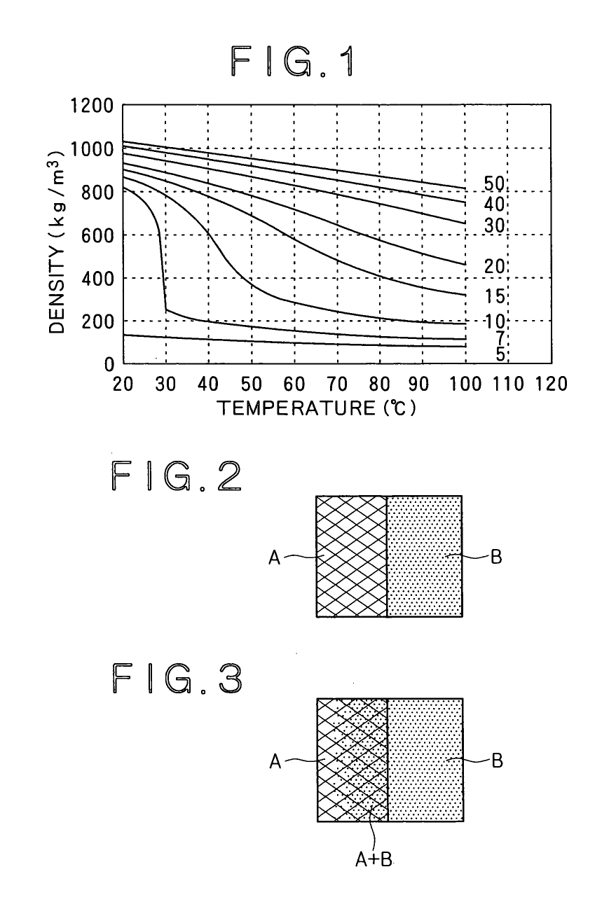

The relationship among the density, temperature and pressure of CO₂ is shown in FIG. 1. The density of CO₂ can be controlled by changing the temperature and/or pressure. Practically, however, the density is preferably controlled by changing the pressure, since control of the pressure is easier than that of the temperature.

With reference to FIG. 1, when the pressure increases from 10 MPa (P1) to 30 MPa (P2) at a constant temperature of 60° C., the density increases 520 kg/m³, i.e., from 300 kg/m³ (d1) to 820 kg/m³ (d2). The ratio of the density after increase to the density before increase is 2.7. CO₂ at 10 MPa has a relatively low density and a relatively high diffusion coefficient. Thus, gases such as the air in a porous material to be impregnated with an agent are easily replaced with CO₂ when the material is brought into contact with the CO₂. In this connection, the agent-containing CO₂ phase has a density slightly higher than that of CO₂ alone not containing the agent. In the following description, however, these two densities are not strictly distinguished, since the concentration of the agent in the phase is very low (1% or less), and it can be said that these densities are interpreted as identical.

The agent-containing phase having a low density comes to have a higher density when the pressure increases from 10 MPa to 30 MPa. The volume change of CO₂ under these conditions will be described.

The volume V1 of CO₂ having a constant weight W is represented by the equation: V1=W/d1, wherein d1 is the density of CO₂ under low pressure. When the density of CO₂ is changed to d2 by changing its pressure or temperature, the volume V2 of CO₂ herein is represented by the equation: V2=W/d2.

The volume change ΔV between before and after the change in temperature or pressure is determined according to the following equations:
ΔV=W(1/d1−1/d2),
ΔV/V1=d1(1/d1−1/d2)

When the pressure is changed from 10 MPa to 30 MPa at a constant temperature of 60° C., d1 is 300 kg/m³ and d2 is 820 kg/m³, and accordingly, ΔV/V1 is 0.63. This means that the volume of CO₂ having the same weight decreases by a factor of 60%. A substance present in CO₂ before volume reduction necessarily moves into a place where CO₂ after volume reduction occupies, which results in rapid movement of the substance.

When the agent-containing CO₂ phase having a low density is in contact with a porous material, the gas such as air encapsulated in the porous material is easily replaced with CO₂, because CO₂ having a low density can sufficiently diffuse and has a low viscosity near to a gas. With an increasing density, the agent is fully mixed with CO₂ and migrates into the core of the porous material. Thus, the porous material can be effectively impregnated with the agent in a short time, without the agent remaining only in a surface layer.

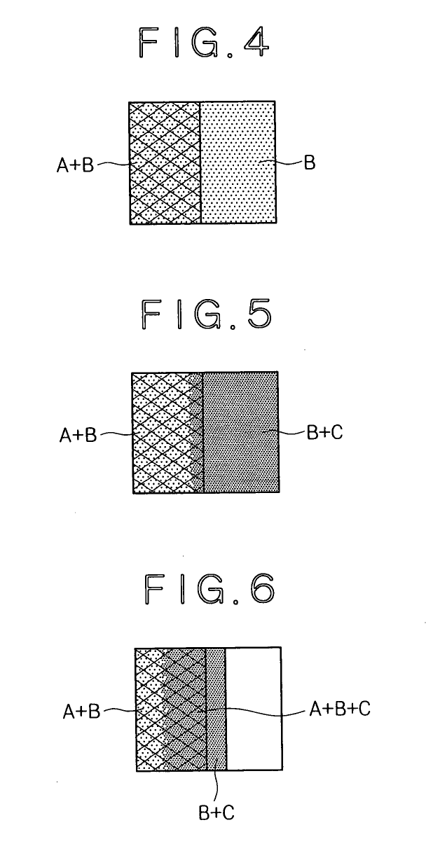

The mechanism of impregnation according to the present invention will be briefly illustrated chronologically with reference to schematic diagrams in FIGS. 2 to 6.

Initially, CO₂ (B) at a constant pressure and a low density is brought into contact with a porous material (A) (FIG. 2). The CO₂ under this condition has high diffusibility and rapidly penetrates the core of the material (A) (FIG. 3) and becomes homogenous (FIG. 4). An agent (C) is then mixed with the CO₂ and diffuses into the CO₂ phase to form an agent-containing phase. Under this condition, the material (A) is impregnated with the agent (C) only in a small amount as a result of diffusion (FIG. 5). Next, the pressure is increases. With an increasing pressure, the CO₂ has an increasing density and has a decreasing volume. The increased density increases the solubility for the agent. Thus, the agent (C) is sufficiently pressed into the core of the material (A) so that the material (A) is sufficiently impregnated with the agent (C) (FIG. 6).

Next, the method of impregnation according to the present invention will be illustrated in more detail including preferred conditions thereof.

According to the present invention, a material is impregnated with an agent by forming an agent-containing phase having a low density and comprising the agent and CO₂ in a supercritical or subcritical state, and increasing the density of the agent-containing phase to thereby impregnate the material with the agent. The “subcritical state” herein means a condition at a temperature equal to or higher than the critical temperature of CO₂ and at a pressure of 5 MPa or more and equal to or less than the critical pressure of CO₂. The following description is made by taking CO₂ in a supercritical state (supercritical CO₂) as an example, but CO₂ in a subcritical state (subcritical CO₂) is also included within the scope of the present invention.

Specifically, it is essential in the present invention to form an agent-containing phase at a low density comprising supercritical CO₂ and an agent so as to enable the agent-containing phase to disperse efficiently. Such an agent-containing phase can be prepared by adding the agent to CO₂ in a supercritical state, as well as by adding the agent to CO₂ in a regular gas state and converting the mixture to a supercritical state. The resulting agent-containing phase must have a relatively lower density than the density at which the material is impregnated with the agent-containing phase.

Next, it is important and essential to increase the density of the agent-containing phase from the low density to a high density while maintaining its supercritical state. In addition, the agent-containing phase must be hold in contact with the material to be impregnated under this condition at a low density, during the process of increasing the density and after the increase of the density.

The density of the agent-containing phase can be increased by changing (lowering) the temperature as described above, but can be more easily changed by changing (increasing) the pressure for easier control. The latter technique is practically preferred. The density can be decreased or increased by decreasing or increasing the pressure thereof, respectively.

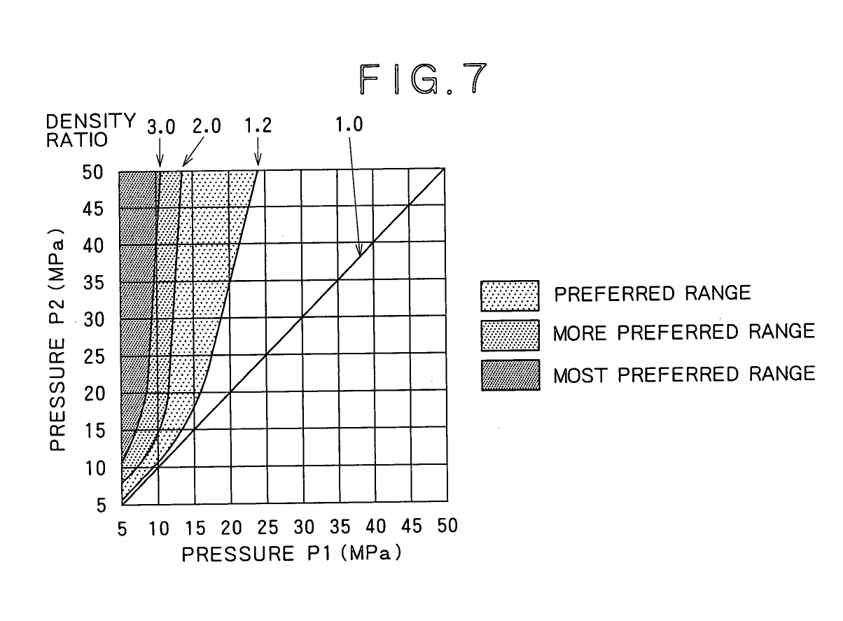

The ratio of the density of the agent-containing phase after increasing (high density) to the density before increasing (low density) is preferably 1.2 or more. FIG. 7 is a graph showing the relationship among the density ratio (d2/d1) and the pressures before (P1) and after (P2) increasing the density, when the density is changed by pressure control according to the present invention. The higher the density ratio is, the more preferable it is for efficiently impregnating the material with the agent. Accordingly, the density ratio is more preferably 2.0 or more and specifically preferably 3.0 or more. If a target density ratio is decided depending typically on the types of the agent and the material, the practical pressure conditions can be easily set using the data shown in FIG. 7. Specifically, P1 is preferably set at 5 to 20 MPa, and P2 is preferably set at 10 to 40 MPa, provided that P2 is larger than P1.

According to the present invention, the relative change in density within the above-specified density ratio must occur in the agent-containing phase containing the agent and CO₂ in a super critical state. The material can be effectively impregnated with the agent through the process of increasing the density. Even if the initial pressure (P0) is high and the agent-containing phase has a high density, the process of increasing the density can be achieved by decreasing the pressure to P1 to yield a low density, and then increasing the pressure to P2 to yield a high density. This process is hereinafter referred to as “Pressure Control Mode 2” as in the after-mentioned examples. This process is advantageous for an agent having a markedly decreased solubility in CO₂ at a low density. The solubility of this agent can be increased by adding the agent to CO₂ at an increased density. In this procedure, P0, P1 and P2 are preferably set at 10 to 40 MPa, S to 20 MPa, and 10 to 40 MPa, respectively.

The material to be impregnated can be fundamentally any material having voids or pores. The above-specified conditions are typically effective for wood or lumber as the material, as shown in the after-mentioned examples.

Examples of the agent to be injected are those for conservation of wood, such as antiseptic agents, anti-termite agents, fungicides and insecticides; adhesives for the preparation of plywood and bonded plywood; and surface treating agents for applying color or feel (texture) to the surface of wood. The agent is preferably an organic agent from the viewpoint of the properties of CO₂, but a water-soluble agent can be used by using an appropriate compatibilizer.

Examples of the organic agent are organophosphorus compounds such as phoxim, chloropyriphos, pyridaphenthion, tetrachlorvinphos, fenitrothion and propetamphos; pyrethroid compounds such as permethrin, tralomethrin and allethrin; pyrethroid analogues such as silafluofen and etofenprox; carbamate compounds such as propoxur and bassa; triazine compounds such as tripropyl isocyanurate; naphthalene compounds such as monochloronaphthalene; tar-derived substances such as creosote oil; chlorinated dialkyl ether additives such as octachlorodipropyl ether; chloronicotinyl compounds such as imidacloprid; organoiodine compounds such as 4-chlorophenyl-3-iodopropargylformal, 3-ethoxycarbonyloxy-1-bromo-1,2-diiodopropene and 3-iodo-2-propynyl butylcarbamate; metal soaps such as copper naphthenate, zinc naphthenate and zinc versatate; hydroxylamine compounds such as aluminum N-nitroso-cyclohexylhydroxylamine; anilide compounds such as N-methoxy-N-cyclohexyl-4-(2,5-dimethylfuran)carbanilide; haloalkylthio compounds such as N,N-dimethyl-N′-phenyl-N′-(fluorodichloromethylthio)sulfamide; nitrile compounds such as tetrachloroisophthalonitrile; phenol compounds such as dinitrophenol, dinitrocresol, chloronitrophenol and 2,5-dichloro-4-bromophenol; quaternary ammonium salts such as didecyldimethylammonium chloride (DDAC) and N-alkylbenzylmethylammonium chloride (BKC); and other compounds such as permethrin, tebuconazole, 2-mercaptobanzothiazole, 2-(4-thiazolyl)benzimidazole (TBZ), 4-chlorophenyl-3-iodopropargylformal (IF-1000), 3-iodo-2-propyl butylcarbamate (IPBC), 2-(4-thiocyanomethyl)benzothiazole (TCMTB) and methylenebis (thiocyanate) (MBT). Each of these agents can be used alone or in combination.

The agent can be effectively mixed with CO₂ by using a compatibilizer. The compatibilizer herein refers to a substance that can dissolve the agents and can be dissolved in CO₂. Examples of the compatibilizer for use in the present invention are alcohols such as methanol, ethanol, 1-propanol, 2-propanol, diethylene glycol monomethyl ether, diethylene glycol monoethyl ether, propylene glycol monomethyl ether and propylene glycol monoethyl ether; hydrocarbons such as pentane, n-hexane, isohexane and cyclohexane; and glycols such as ethylene glycol, propylene glycol and diethylene glycol.

The method of impregnation according to the present invention will be illustrated in further detail with reference to several examples below, which are never intended to limit the scope of the invention.

1) Test Piece

A piece of lumber having a 20-mm square cross section and a length of 100 mm was used as a test piece. The lumber was derived from Japanese cedar or larch including a piece cut from the periphery of the trunk (hereinafter briefly referred to as “peripheral piece”) and a piece cut from a center part thereof (hereinafter briefly referred to as “core piece”). The test pieces were cut 100 mm long in a direction of growth of the trunk and 20 mm wide in a direction perpendicular thereto.

2) Agent

A 10 percent by weight solution of zinc versatate, a metal soap, in a petroleum solvent was used as the agent. The impregnation of lumber with the agent was determined by cutting the lumber after the impregnation test in a cross sectional direction, applying a solution of dithizone in chloroform to the cross section and observing the development of red color. The depth of a region developing red was determined and defined as an indicator of the impregnation.

3) Test Method

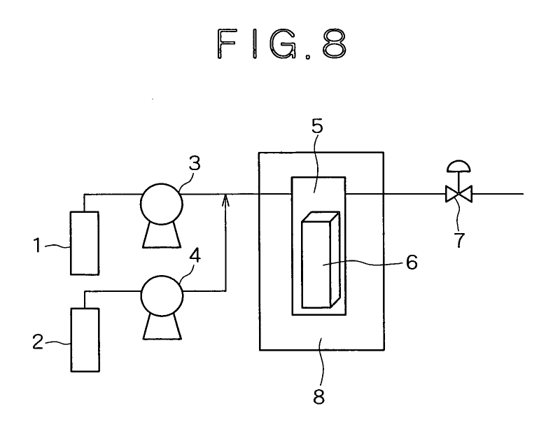

FIG. 8 is a flowchart of an apparatus used in the test. Initially, a porous material (test piece of lumber) 6 was placed in a high-pressure vessel 5. The high-pressure vessel 5 was held to a set temperature by the action of a heater or thermostat bath 8. CO₂ was fed into the high-pressure vessel 5 from a CO₂ cylinder 1 by the action of a CO₂ pump 2. In this procedure, the set pressure of a pressure control valve 7 was set to a predetermined pressure P1. The pressure control valve 7 serves to automatically open and close the valve so as to keep the system to a predetermined pressure.

The present invention provides two procedures for changing the pressure, i.e., a procedure in which the agent is injected under low pressure, and a procedure in which the agent is injected under high pressure. The former and the latter are referred to as “Pressure Control Mode 1” and “Pressure Control Mode 2”, respectively. P1 and P2 are symbols representing pressures, and the following description is made provided that P2 is larger than P1.

In Pressure Control Mode 1, the solution of zinc versatate serving as the agent in a compatibilizer was introduced into the system using an agent solution pump 4, after the pressure of the system reached to the set pressure P1. After keeping the system to a pressure P1 for a predetermined time, such as ten minutes, the set pressure of the pressure control valve 7 was changed to P2. Then the pressure of the system was changed from P1 to P2. After the pressure of the system reached the predetermined pressure P2, this condition was held for a predetermined time, such as thirty minutes. Then, the set pressure of the pressure control valve 7 was returned to P1 to thereby return the pressure of the system to P1. A pressure change cycle comprising the change of pressure from P1 to P2 to P1 was repeated one or more times. Finally, the agent solution pump 4 was turned off, the set pressure of the pressure control valve 7 was set to 0 MPa to reduce the pressure of the system, and the test piece was taken out from the system.

In Pressure Control Mode 2, the pressure was increased to P0. After the pressure reached to P0, the solution of zinc versatate serving as the agent in a compatibilizer was introduced into the system using an agent solution pump 4. After keeping the system under this condition at the set pressure of P0 for a predetermined time, such as ten minutes, the set pressure of the pressure control valve 7 was set to P1. After the pressure of the system reduced to P1, the same condition was held for a predetermined time, such as thirty minutes. Next, the set pressure was changed to P2 to thereby increase the pressure of the system to P2. The process of increasing the pressure from P1 to P2, namely the process of increasing the density of the agent-containing phase in a supercritical state from a low density to a high density is essential, as described in the principle and mechanism of the present invention.

Another test was carried out at a constant pressure P1 as comparative examples (hereinafter referred to as “Constant PressureMode”). The impregnation of the test piece with the agent was determined by cutting the lumber after the impregnation test in a cross sectional direction, applying a solution of dithizone in chloroform to the cross section and observing the development of red color.

The test conditions and results in the examples (Pressure Control Modes 1 and 2) and the comparative examples (Constant Pressure Mode) are shown in Table 1.

TABLE 1

| | | | Compatibilizer | | | | | | | |
|---|---|---|---|---|---|---|---|---|---|---|
| | | Concentration | | Concentration | Pressure (MPa) | | | | Density | Impregnation |
| | Material test piece | of agent (wt %) | Type | (wt %) | Mode | P0 | P1 | P2 | ratio *1 | depth *2 (mm) |
| Com. Ex. 1 | Japanese cedar peripheral piece | 0.05 | hexane | 4.5 | Constant | — | 15 | — | 1 | ≦1 |
| Com. Ex. 2 | Japanese cedar peripheral piece | 0.05 | ethanol | 4.5 | Constant | — | 15 | — | 1 | ≦1 |
| Com. Ex. 3 | Japanese cedar peripheral piece | 0.05 | ethanol | 4.5 | Constant | — | 30 | — | 1 | ≦1 |
| Com. Ex. 4 | Japanese cedar peripheral piece | 0.25 | ethanol | 2.5 | Constant | — | 30 | — | 1 | ≦1 |
| Com. Ex. 5 | Japanese cedar peripheral piece | 0.50 | ethanol | 2.5 | Constant | — | 30 | — | 1 | ≦1 |
| Ex. 1 | Japanese cedar peripheral piece | 0.05 | ethanol | 4.5 | Control Mode 1 | — | 7 | 30 | 5.4 | 5 |
| Ex. 2 | Japanese cedar peripheral piece | 0.25 | ethanol | 2.5 | Control Mode 1 | — | 7 | 30 | 5.4 | ≧10 |
| Ex. 3 | Japanese cedar peripheral piece | 0.25 | ethanol | 2.5 | Control Mode 1 | — | 15 | 30 | 1.4 | 5 |
| Ex. 4 | Japanese cedar core piece | 0.25 | ethanol | 2.5 | Control Mode 1 | — | 7 | 15 | 3.8 | ≧10 |
| Ex. 5 | Japanese cedar core piece | 0.25 | ethanol | 2.5 | Control Mode 1 | — | 7 | 30 | 4.6 | ≧10 |
| Ex. 6 | Japanese cedar core piece | 0.25 | ethanol | 2.5 | Control Mode 1 | — | 10 | 30 | 2.9 | ≧10 |
| Ex. 7 | larch core piece | 0.25 | ethanol | 2.5 | Control Mode 1 | — | 7 | 15 | 3.8 | ≧10 |
| Ex. 8 | larch core piece | 0.25 | ethanol | 2.5 | Control Mode 1 | — | 7 | 30 | 4.6 | ≧10 |
| Ex. 9 | larch core piece | 0.25 | ethanol | 2.5 | Control Mode 1 | — | 10 | 30 | 2.9 | ≧10 |
| Ex. 10 | larch core piece | 0.25 | ethanol | 2.5 | Control Mode 2 | 15 | 7 | 15 | 3.8 | ≧10 |
| Ex. 11 | larch core piece | 0.25 | ethanol | 2.5 | Control Mode 2 | 30 | 7 | 30 | 4.6 | ≧10 |
| Ex. 12 | larch core piece | 0.25 | ethanol | 2.5 | Control Mode 2 | 30 | 10 | 30 | 2.9 | ≧10 |

*1: Density ratio = (density of CO₂ at pressure of P2)/(density of CO₂ at pressure P1) (the density ratio is 1 in Constant Pressure Mode.
*2: “≦1”: the impregnation depth is 1 mm or less; “≧10”: the impregnation depth is 10 mm or more

5) Results

### REFERENTIAL EXAMPLE

### Under Pressure with CO₂ Alone

A larch core piece was treated with CO₂ alone in Constant Pressure Mode in which the pressure P1 was set at 15 MPa or 30 MPa at a set temperature of 60° C. without using a compatibilizer and zinc versatate. The larch core piece did not change its size between before and after the treatment and showed no crack. This result shows that CO₂ can easily penetrate the lumber without differential pressure between the inside and outside of the lumber.

### COMPARATIVE EXAMPLES 1 TO 5

### Constant Pressure Mode

A Japanese cedar piece was treated in Constant Pressure Mode using hexane or ethanol as a compatibilizer at a set temperature of 60° C., a set pressure of 15 MPa or 30 MPa and a concentration of zinc versatate of 0.5 to 5 percent by weight. The impregnation states of the agent after the treatments are shown in Table 1 as Comparative Examples 1 to 5. The depth of impregnation with zinc versatate did not exceed 1 mm in these comparative examples. The thickness of the test pieces was 20 mm. The results show that impregnation with the agent in a depth direction is limited only in the vicinity of the surface under these conditions.

### EXAMPLES 1 TO 3

A Japanese cedar peripheral piece was impregnated with the agent according to Pressure Control Mode 1 of the present invention at a set temperature of 60° C. by repeating the pressure change cycle of 60 minutes two times. In Example 1, the test piece was treated with the agent according to Pressure Control Mode 1 in a concentration of the agent of 0.05 percent by weight, at a pressure P1 of 7 MPa, a pressure P2 of 30 MPa and a density ratio of 5.4. In Examples 2 and 3, the treatment was carried out according to Pressure Control Mode 1 at an agent concentration of 0.25%. According to Example 1, the test piece was impregnated with the agent not fully but to a depth of about 5 mm from the surface, since the agent concentration was low as compared with the other examples. The test piece was impregnated with the agent more than those according to Comparative Examples 2 and 3 where the impregnation was carried out at the same agent concentration but according to Constant Pressure Mode.

In Example 2, the impregnation was carried out in Control Mode 1 at a pressure P1 of 15 MPa, a pressure P2 of 30 MPa, a density ratio of 5.4 and an agent concentration of 0.25 percent by weight, and the test piece was fully impregnated with the agent. In this case, the test lumber piece was 20 mm square in its cross section, and the impregnation depth can be determined as 10 mm or more and is indicated as “>10 mm” in Table 1 (the same is true for the other examples). In Example 3, the impregnation was carried out in Pressure Control Mode 1 at a pressure P1 of 7 MPa, a pressure P2 of 30 MPa, a density ratio of 1.4 and an agent concentration of 0.25 percent by weight, and the test piece was impregnated with the agent to a depth of about 5 mm, lower than that in Example 2. This is because the density ratio in Example 3 is lower than that in Example 2.

### EXAMPLES 4 TO 6

In these examples, a Japanese cedar core piece having a density higher than that of Japanese cedar peripheral piece was impregnated with the agent according to Pressure Control Mode 1. The entire cross section of the test piece was impregnated with the agent at a pressure P1 of 7 or 10 MPa, a pressure P2 of 15 or 30 MPa and a density ratio of 3.8, 4.6 or 2.9, respectively.

### EXAMPLES 7 TO 9

In these examples, a larch lumber was treated. Such a larch lumber is believed not to be impregnated with an agent without cracking according to the liquid pressurizing method. The entire cross section of the test piece was fully impregnated with the agent according to Pressure Control Mode 1 at a pressure P1 of 7 or 10 MPa, a pressure P2 of 15 or 30 MPa, and a density ratio of 3.8, 4.6 or 2.9, respectively.

### EXAMPLES 10 TO 12

In these examples, a larch lumber was treated according to Pressure Control Mode 2, in which the agent was added at a relatively high pressure of P0 of 15 or 30 MPa, the pressure was then decreased to P1 of 7 or 10 MPa, and was then increased to P2 of 15 or 30 MPa. The density ratio was 3.8, 4.6 or 2.0. As a result, the entire cross section of the test piece was fully impregnated with the agent.

These results show that the impregnation method of the present invention (Pressure Control Modes) can more satisfactorily impregnate a material with an agent than in the comparative examples according to Constant Pressure Mode, and that the lumber can be reliably impregnated with the agent to a depth of 10 mm or more at a density ratio (P1/P2) of the density after pressure increase to that before pressure increase of 3.0 or more.

1. A method for impregnating a material with an agent, comprising the steps of:
forming an agent-containing phase having a low density and comprising an agent and carbon dioxide in a supercritical or subcritical state; and
increasing the density of the agent-containing phase to thereby impregnate the material with the agent.

2. The method according to claim 1, wherein the material is wood or lumber.

3. The method according to one of claim 1, further comprising increasing the pressure on the agent-containing phase to thereby increase the density of the agent-containing phase.

4. The method according to claim 2, comprising the steps of:
mixing the agent with carbon dioxide to form an agent-containing phase;
bringing the wood into contact with the agent-containing phase at a pressure of 5 to 20 MPa; and
increasing the pressure to 10 to 40 MPa to thereby impregnate the wood with the agent.

5. The method according to claim 3, comprising the steps of:
bringing wood into contact with carbon dioxide at a pressure of 10 to 40 MPa;
adding the agent to the carbon dioxide being in contact with the wood;
reducing the pressure to 5 to 20 MPa; and
increasing the pressure to 10 to 40 MPa to thereby impregnate the wood with the agent.

6. The method according to claim 3, wherein the ratio of the increased density of the agent-containing phase to that before increasing is 1.2 or more.
